(19) United States
(12) Patent Application Publication
(10) Pub. No.: US 2014/0199677 A1
(43) Pub. Date: Jul. 17, 2014

(54) Modular Multi-Element Constructions From Rearrangeable Pieces And Kits Allowing Construction Of Same

(71) Applicant: GoldieBlox, Inc., (US)

(72) Inventor: Debra Glasband, San Francisco, CA (US)

(73) Assignee: GoldieBlox, Inc., Oakland, CA (US)

(21) Appl. No.: 13/831,776

(22) Filed: Mar. 15, 2013

Related U.S. Application Data
(60) Provisional application No. 61/696,094, filed on Aug. 31, 2012.

(51) Int. Cl. A63H 33/04; G09B 19/00

(52) U.S. Cl. CPC A63H 33/042; G09B 19/00; A63H 33/048
USPC 434/365; 446/102

(57) ABSTRACT

Board-based machines assembled from components including crank and winch attributes which allow for coupling between the components, and which allows the user to position various elements into desired positions. A kit of components including coupling attributes which allow for assembly into a large number of different types of machines and structures of different types and shapes. A book adapted to teach children about mechanical aspects of design in concert with a kit of components adapted to be used to create board based machines.

### CROSS-REFERENCE TO RELATED APPLICATIONS

This application claims priority to U.S. Provisional Patent Application No. 61/696,094 to Glasband, filed Aug. 31, 2013, which is hereby incorporated by reference in its entirety.

### BACKGROUND

1. Field of the Invention

The present invention relates to modular toy elements which can be assembled and arranged into working machines, and to kits with a variety of such elements.

2. Description of Related Art

Modeling kits typically comprise a plurality of pieces of different types. A structural item may be formed by interconnecting various pieces. Modeling kits are used by children, hobby enthusiasts, educators, and the like. The assembly of a model can be used as an educational tool to teach school age children.

A versatile modeling kit would allow for the creation of a variety of items, such as structures and other items from a fixed plurality of items that could be used in these different applications. A versatile modeling kit may allow for the construction of mechanically interrelated pieces, such as rotating items, into a complex assembly, while also incorporating some ornamental elements which may better retain the attention of a young child.

What is called for is a modeling kit comprising pieces that may be easily assembled into a variety of different types of items. What is also called for are machines assembled from such pieces that are easily assembled and disassembled, and which allow for the gaining of understanding of mechanical devices and relationships by the user.

### SUMMARY

Board-based machines assembled from components including crank and winch attributes which allow for coupling between the components, and which allows the user to position various elements into desired positions. A kit of components including coupling attributes which allow for assembly into a large number of different types of machines and structures of different types and shapes. A book adapted to teach children about mechanical aspects of design in concert with a kit of components adapted to be used to create board based machines.

### BRIEF DESCRIPTION OF THE DRAWINGS

FIG. 1 illustrates mounting board according to some embodiments of the present invention.

FIG. 2 illustrates a shaft according to some embodiments of the present invention.

FIG. 3 illustrates a wheel according to some embodiments of the present invention.

FIG. 4 illustrates a crank arm according to some embodiments of the present invention.

FIG. 5 is an exploded view of a wheel and crank assembly according to some embodiments of the present invention.

FIG. 6 illustrates an embodiment of an assembled mechanism in a single plane according to some embodiments of the present invention.

FIG. 7 illustrates an embodiment of a multi-board assembled mechanism according to some embodiments of the present invention.

FIG. 8 illustrates an embodiment of a raised board mechanism according to some embodiments of the present invention.

FIG. 9 illustrates a right angle wheel drive design according to some embodiments of the present invention.

FIG. 10 illustrates a right angle wheel drive design according to some embodiments of the present invention.

### DETAILED DESCRIPTION

In some embodiments of the present invention, a kit of pieces adapted to be constructed into a variety of shapes, and into a variety of configurations, allows for the construction of machines which may illustrate for the user, especially a child, aspects of mechanical relationships. The kit of pieces may be used in conjunction with a book which may act as an instruction book on how to assemble various configurations which incorporate mechanical relationships. The kit may include ornamental pieces which may be incorporated into the mechanical design pieces and which may further enhance the experience for a young child. It will be appreciated, as the following description of the various pieces proceeds, that a kit made according to the teachings of the present invention can include any number and variety of the pieces described herein.

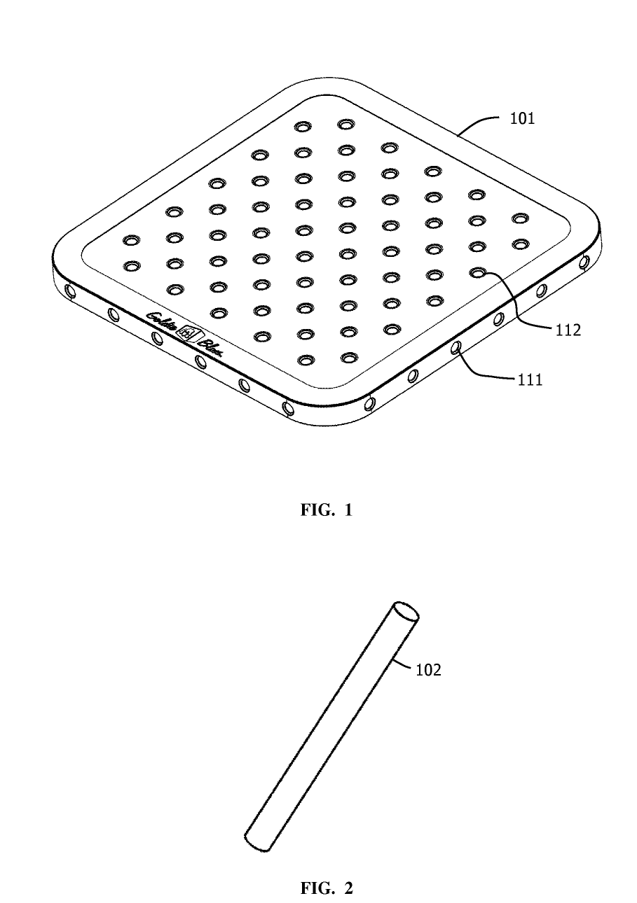

FIG. 1 illustrates a mounting board 101 adapted to act as the base for the building of a variety of types of mechanisms with the use of a kit of piece part elements. The mounting board 101 has a plurality of top holes 112 spaced in a pattern which allow a variety of insertion points into the top holes 112, which have an axis perpendicular to the main plane of the mounting board 101. The mounting board has a plurality of side holes 111 space along the edge of the mounting board 101. The side holes have an axis parallel to the main plane of the mounting board 101, and allow for insertion into the sides of the mounting board 101.

FIG. 2 illustrates a shaft 102 adapted to be used for a variety of purposes. The shaft 102 may be a long, narrow cylinder. The shaft 102 is adapted to be inserted in the top holes 112 or the side holes 111 and may be retained with some gripping force due to a minor interference fit, or through other gripping means. In some aspects, the shaft 102 may be used to support a wheel as an axle. In some aspects, shafts 102 may be used to join mounting boards 101 together.

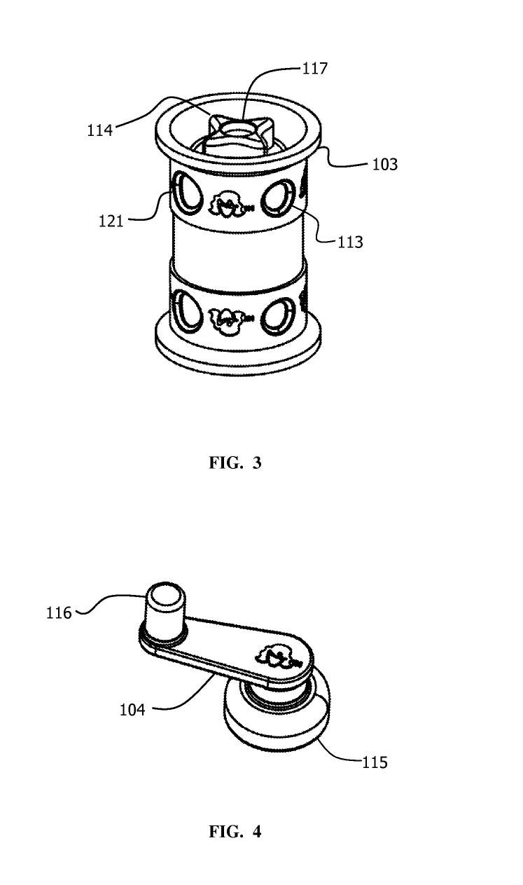

FIG. 3 illustrates a wheel 103 adapted to be used for a variety of purposes. The wheel 103 has a hole 117 which may allow for the placement of the wheel 103 over a shaft 102 in some aspects. The wheel 103 has a wheel fitting 114 adapted to interlock with a crank handle to allow for manual cranking of the wheel 103. The wheel 103 may also have holes 113 which may allow for insertion of one or more shafts 102 through the wheel. The wheel 103 may also have holes 121 which may allow for insertion of shaft 102 with some gripping force due to a minor interference fit. In some embodiments, the wheel 103 may have a surface along its exterior radial periphery adapted to allow for the application of mechanical advantage. This surface may be part of a hook and loop fastening system, allowing rotation of the wheel 103 to be translated into linear motion of a ribbon 106 which has the mating part of the hook and loop fastening system thereon. In some aspects, character figures may have a mating interface for the wheel fitting such that the character figure may mount on the wheel.

FIG. 4 illustrates a crank arm 104 adapted to be used in conjunction with a wheel 103. The crank arm 104 has a crank fitting 115 adapted to mate with a wheel fitting 103 in order to allow a user to rotate a wheel 103 by cranking the crank handle 116 of the crank arm 104. In cases wherein the wheel 103 has a loop or hook surface, the cranking of the wheel translates rotary motion of the crank arm 104 into a linear motion of the ribbon 106. In some aspects, a plurality of wheels may be interlinked with a ribbon, or other flexible element, and all of the wheels may be rotated with the cranking of a single crank arm engaged with the ribbon. In some aspects, wheels other than the wheel with the crank arm may have character figures mounted thereon, allowing for rotation of the character figures on the wheels engaged on the ribbon with the rotation of the crank arm. The use of a ribbon may enhance a playful aspect of the use of the kit by children, while simultaneously allowing the child to learn about mechanical relationships.

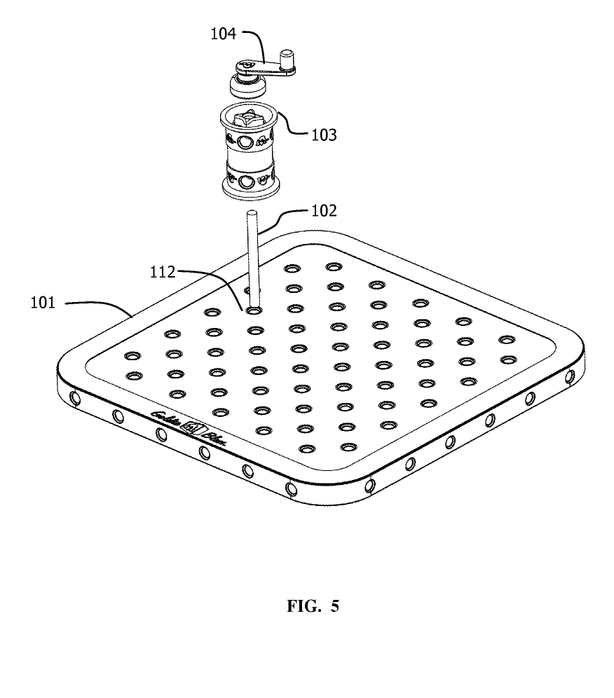

FIG. 5 is an exploded perspective view illustrating the use of a mounting board 101 as a base for a wheel assembly. A shaft 102 is inserted into a top hole 112 of the mounting board 101. A wheel 103 is placed over the shaft 102. The wheel 103 is then able to spin freely around a vertical axis. A crank arm 104 is placed onto the top of the wheel 103 through the interlocking of the wheel fitting 114 and the crank fitting 115. When assembled in this manner, the crank arm allows for the rotation of the wheel 103 by the user.

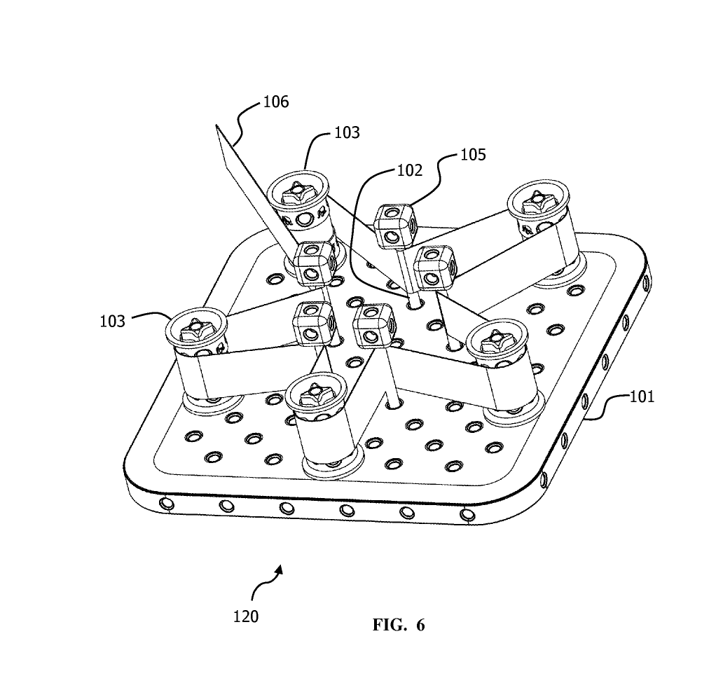

FIG. 6 illustrates an exemplary machine assembly 120 according to some embodiments of the present invention. A mounting board 101 is seen with a plurality of wheels 103 mounted thereon. The wheels 103 are placed on shafts 102 inserted into top holes 112 in the mounting board 101. A ribbon 106 is threaded in a serpentine pattern around the wheels 103. Other shafts 102 are mounted into top holes 112 and are used as guide posts for the serpentine ribbon path. The shafts used as guide posts have caps 105 mounted onto their top ends. With the engagement of the hook and loop portion on the ribbon with the portion on the wheels, the pulling of the ribbon 106, whether by hand or with the use of a wheel with a crank mounted thereon, will cause the rotation of all of the wheels 103. For example, the hooks may be on the central engagement portion of the wheels, and the loops may be integral to one or both sides of the ribbon. When character figures are mounted on the wheels 103, the rotation of the wheels 103 will cause the rotation of the character figures. With a kit of pieces, which may include a plurality of shafts, wheels, and caps, the user may create numerous configurations of integrated machines which may move in a synchronous manner.

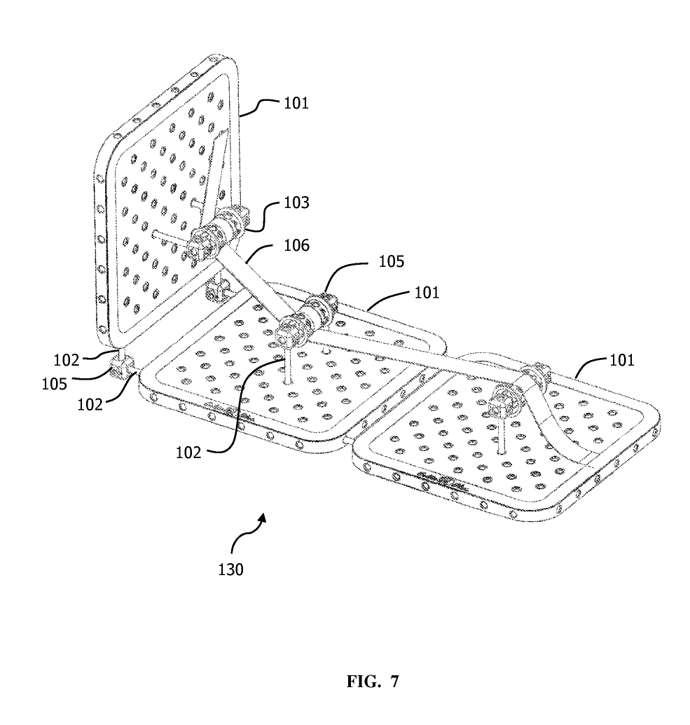

FIG. 7 illustrates an exemplary machine assembly 130 according to some embodiments of the present invention. A plurality of mounting boards 101 are seen with a plurality of wheels 103 mounted thereon. The wheels 103 are placed on shafts 102 mounted horizontally between caps 105 on shafts 102 inserted into top holes 112 in the mounting board 101. A ribbon 106 is threaded in a linear pattern around the wheels 103. In embodiments such as this, two boards 101 are attached at right angles to each other. Shafts 102 are linked with caps 105 to effect a right angle attachment between two of the mounting boards 101. With the engagement of the hook and loop portion on the ribbon with the portion on the wheels, the pulling of the ribbon 106, whether by hand or with the use of a wheel with a crank mounted thereon, will cause the rotation of all of the wheels 103. With a kit of pieces, which may include a plurality of shafts, wheels, and caps, the user may create numerous configurations of integrated machines which may move in a synchronous manner.

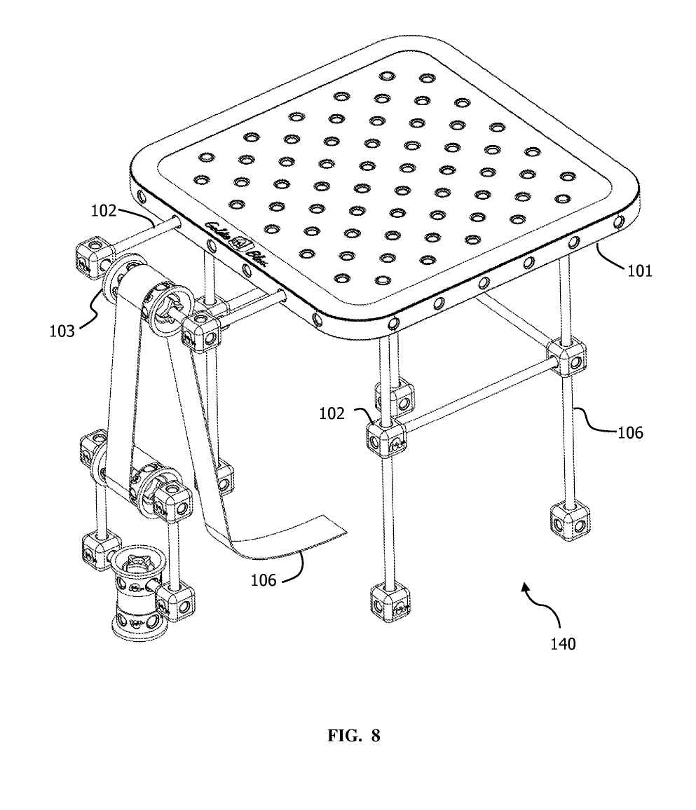

FIG. 8 illustrates an exemplary machine assembly 140 according to some embodiments of the present invention. A mounting board 101 is seen with a plurality of shafts 102 mounted thereon. Wheels 103 are placed on shafts 102 mounted horizontally between caps 105 on shafts 102 inserted into side holes 111 in the mounting board 101. A ribbon 106 is threaded in a linear pattern around the wheels 103. The ribbon finds friction with the wheel with hook and loop features, and then may be threaded around another wheel to create a pulley mechanism. Where the ribbon is pulled, the wheel/shaft/cap combination may lift upward off the mounting surface. In embodiments such as this, shafts are used as supports of the mounting board to raise it off of the mounting surface. Shafts 102 are linked with caps 105 to effect a right angle or continuation attachments between two or more of the shafts. Longer shafts may be part of the kit of pieces available to the user in some embodiments.

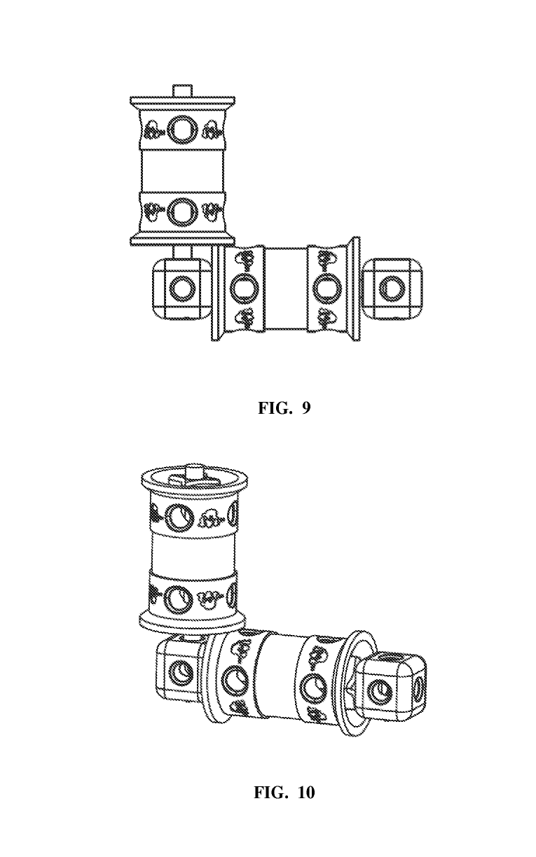

FIGS. 9 and 10 illustrate using wheels mounted adjacently at right angles in order to create a driving effect from a first wheel to a second wheel. In addition to the driving of a wheel by the use of a ribbon, wheels mounted adjacently, and at right angles to each other, may drive one another through frictional engagement.

In an exemplary embodiment, a mounting board may be 24.5 cm square and 1.5 cm thick, with 0.7 cm holes on 3.65 cm spacings, offset. The shaft may be 6.5 cm long and 0.6 cm in diameter, with longer shaft pieces at 13 cm long. The wheels may be 5 cm in height and 3.5 cm in diameter, with the 1.4 cm loop side of the hook and loop fasteners affixed thereon. The ribbon/tape may be 3 cm wide with different lengths (for example 4 feet long) with a 3 cm×1.5 cm hook side of the hook and loop fasteners affixed thereon.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. An assembly kit for toy use comprising:
one or more mounting boards, said mounting boards comprising:
a first plurality of top holes across a broad surface of said mounting boards; and
a first plurality of side holes along a side perimeter of said mounting boards;
a plurality of shaft elements, said shaft elements adapted to fit within said first plurality of top holes, said shaft elements adapted to fit within said plurality of side holes; and
a plurality of wheel pieces, said wheel pieces being substantially cylindrical, said wheel pieces comprising a central hole along a central axis of the wheel cylinder, said central hole adapted to receive a shaft element.

2. The assembly kit of claim 1 wherein said wheel pieces further comprise a hook and loop fastening element along an outer surface of said wheel cylinder.

3. The assembly kit of claim 2 further comprising a ribbon, said ribbon comprising a hook and loop fastening element along a first side of said ribbon.

4. The assembly kit of claim 3 further comprising a crank arm, said crank arm comprising a coupling interface adapted to couple to a mating interface on the end of a wheel piece.

5. The assembly kit of claim 4 further comprising one or more character figures, said character figures comprising a coupling interface adapted to couple to a mating interface on the end of a wheel piece.

6. The assembly kit of claim 1 further comprising a storybook, said storybook comprising narrative-style instructions on how to use the components of said assembly kit.

7. The assembly kit of claim 1 wherein said wheel pieces further comprise a first plurality of horizontal holes sized for loose fit with said shafts.

8. The assembly kit of claim 1 wherein said wheel pieces further comprise a second plurality of horizontal holes sized for interference fit with said shafts.

9. The assembly kit of claim 8 wherein said wheel pieces further comprise a second plurality of horizontal holes sized for interference fit with said shafts.

10. The assembly kit of claim 4 further comprising a plurality of extension elements, said extension elements being straight elements.

11. A method for teaching a child about mechanical concepts, said method comprising the steps of:
providing a child with a storybook, said storybook comprising discussion of pieces,
providing said child with an assembly kit, wherein said assembly kit comprises:
one or more mounting boards, said mounting boards comprising:
a first plurality of top holes across a broad surface of said mounting boards; and
a first plurality of side holes along a side perimeter of said mounting boards, said extension elements being straight elements;
a plurality of shaft elements, said shaft elements adapted to fit within said first plurality of top holes, said shaft elements adapted to fit within said plurality of side holes; and
a plurality of wheel pieces, said wheel pieces being substantially cylindrical, said wheel pieces comprising a central hole along a central axis of the wheel cylinder, said central hole adapted to receive a shaft element.
